(19) United States
(12) Patent Application Publication
(10) Pub. No.: US 2008/0278302 A1
(43) Pub. Date: Nov. 13, 2008

(54) Electric Vehicle, A Display Device For An Electric Vehicle And A Method Of Displaying Information

(75) Inventors: Ian Palmer, Christchurch (NZ); Richard Rogers, Christchurch (NZ); Anthony Mulick, Chirstchurch (NZ); Piers Seed, Christchurch (NZ)

Correspondence Address: KENYON & KENYON LLP, 1500 K STREET N.W., SUITE 700, WASHINGTON, DC, 20005, US

(73) Assignee: DYNAMIC CONTROLS, Christchurch (NZ)

(21) Appl. No.: 11/630,377

(22) PCT Filed: Jun. 23, 2005
(86) PCT No.: PCT/NZ2005/000138

§ 371 Date: Mar. 3, 2008

(30) Foreign Application Priority Data
Jun. 25, 2004 (NZ) 533770

(51) Int. Cl. B60Q 1/00; G01P 1/08; G01P 1/10; G01D 7/00; G09F 9/302; B60L 15/00; B60W 20/00

(52) U.S. Cl. 340/441; 180/65.8; 701/22

(57) ABSTRACT

An electric vehicle and display device for an electric vehicle having a plurality of display elements (including 10a, 10d and 10j). In one embodiment display elements (10a, 10d) are actuated in proportion to the ratio of actual vehicle speed to the maximum allowable speed for a given mode of operation. In another embodiment a display element (10j) is driven to indicate the maximum allowable speed for a selected mode of 10d operation. In another embodiment the estimated speed of the electric vehicle is based upon user input only.

### FIELD OF THE INVENTION

The invention relates to an electric vehicle, particularly to a powerchair, scooter or like electric vehicle. The invention also relates to a display device for electric vehicle, and in particular to the display of current and maximum allowable vehicle speed. The invention also relates to methods for the display of vehicle speed information.

### BACKGROUND TO THE INVENTION

The speed of powerchairs, scooters and the like is typically controlled by a “speed pot” (a potentiometer controlled by a knob), a joystick or up/down buttons. Where a “speed pot” is employed the current speed of the electric may be indicated by the position of the knob.

Speedometers are sometimes employed but they are expensive as they require components to make actual speed measurements. Where employed they are generally implemented as numerical displays, typically LCD displays, displaying absolute speed.

Some electric vehicles adjust the maximum allowable speed in dependence upon the mode of operation of the electric vehicle. If a seat of the vehicle is raised the maximum allowable speed may be reduced. Likewise, the maximum allowable speed may be adjusted according to user profile information (i.e. functionality appropriate to the capacity of the user) or operating conditions (i.e. indoor/outdoor use).

When the mode of operation changes the user receives no indication that the maximum allowable speed is changing or what the maximum allowable speed in that mode is. To a user absolute speed information is generally of less importance than an indication of current speed in the context of maximum allowable speed and maximum allowable speed (i.e. what is the maximum allowable speed and how fast am I going compared to the maximum allowable speed?).

It is an object of the present invention to provide an electric vehicle, a display device for electric vehicle and a method of displaying information that effectively communicates the maximum allowable speed and/or the speed of the vehicle relative to the maximum allowable speed or to at least provide the public with useful choice.

### SUMMARY OF THE INVENTION

According to a first aspect of the invention there is provided an electric vehicle including: a user input device;

one or more drive motor for driving one or more wheel of the vehicle;

a controller for providing drive signals to the one or more drive motor in response to user input via the user input device, wherein the controller is operable in a plurality of modes allowing different maximum operating speeds; and

a plurality of display elements driven by the controller to indicate vehicle speed, wherein vehicle speed is indicated by activating a proportion of display elements corresponding to the ratio of the actual speed of the vehicle to a maximum allowable speed for the mode of operation.

According to further aspect of the invention there is provided an electric vehicle including:

a user input device;

one or more drive motor for driving one or more wheel of the vehicle;

a controller for providing drive signals to the one or more drive motors in response to user input is via the user input device, wherein the controller is operable in a plurality of modes allowing different maximum operating speeds; and

a plurality of display elements driven by the controller to indicate vehicle speed, wherein an indication of the maximum allowable speed for the selected mode of operation is indicated by one or more display element.

According to another aspect of the invention there is provided an electric vehicle including:

a user input device;

one or more drive motor for driving one or more wheel of the vehicle;

a controller for providing drive signals to the one or more drive motors in response to user input via the user input device; and

a speed display device which indicates the speed of the electric vehicle in response to signals from the controller, wherein the controller determines the estimated speed of the electric vehicle based upon user input.

According to further aspect of the invention there is provided a display device for an electric vehicle capable of operating in a number of modes having different maximum operating speeds wherein the display device includes a number of display elements which display the speed of the vehicle by actuating a proportion of the display elements corresponding to the ratio of the speed of the vehicle to a maximum allowable speed for the mode of operation.

According to another aspect of the invention there is provided a display device for an electric vehicle capable of operating in a number of modes having different maximum allowable speeds wherein the display device includes one or more display element which displays the maximum allowable speed of the vehicle for the selected mode of operation.

According to further aspect of the invention there is provided a display device for an electric vehicle capable of operating in a number of modes having different maximum allowable speeds wherein the display device includes one or more display element which displays the maximum allowable speed of the vehicle for the selected mode of operation.

According to another aspect of the invention there is provided a method of displaying the speed of an electric vehicle capable of operating in a plurality of modes allowing different allowable speeds, comprising displaying the speed of the vehicle by actuating a proportion of display elements corresponding to the proportion of a current speed value of the vehicle to a maximum speed value of the vehicle for a given mode of operation.

According to further aspect of the invention there is provided a method of displaying the maximum allowable speed of an electric vehicle capable of operating in a plurality of modes allowing different maximum operating speeds, comprising actuating one or more display elements corresponding to the maximum speed value of the vehicle for a given mode of operation.

According to a still further aspect of the invention there is provided a method of displaying the speed of an electric vehicle capable of operating in a number of modes allowing different maximum operating speeds by displaying that a maximum speed value for a selected mode of operation has been attained by actuating all display elements of a vehicle speed display.

### BRIEF DESCRIPTION OF THE DRAWINGS

The invention will now be described by way of example with reference to the accompanying drawings in which:

FIG. 1 shows the major components of an electric vehicle in block diagram form;

FIG. 2 shows a vehicle speed display device consisting of a number of display elements;

FIG. 3 shows a method of indicating current vehicle speed and maximum allowable speed;

FIG. 4 shows the method shown in FIG. 3 when maximum allowable vehicle speed is reduced;

FIG. 5 shows an alternative method for displaying current vehicle speed and maximum allowable speed;

FIG. 6 shows the method shown in FIG. 5 when maximum allowable vehicle speed is reduced;

FIG. 7 shows a further alternative method for displaying current vehicle speed and maximum allowable speed;

FIG. 8 shows a further alternative method for displaying current vehicle speed and maximum allowable speed;

FIG. 9 shows an implementation utilising an LCD;

FIG. 10 shows a method for displaying current vehicle speed where the display is rescaled according to maximum allowable speed for a given mode of operation;

FIG. 11 shows a variant of the method shown in FIG. 10.

### MODES FOR CARRYING OUT THE INVENTION

The invention may be implemented in a variety of electric vehicles such as powerchairs, scooters etc. The general operation of such an electric vehicle is well-known.

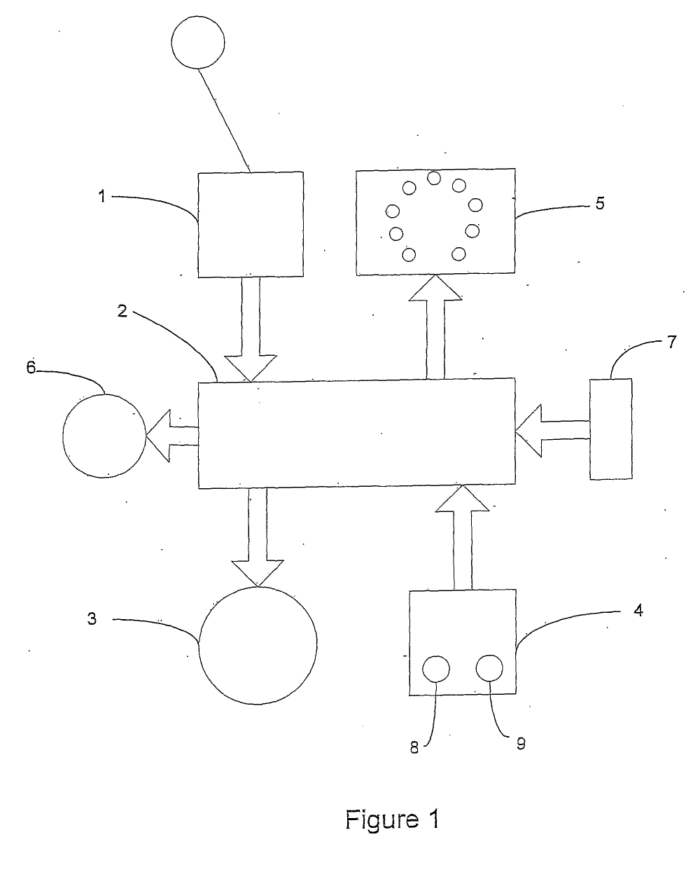

FIG. 1 shows in block diagram form the major electrical and electronic components of an electric vehicle according to one embodiment. A controller 2 receives inputs from user input devices such as joystick 1 and user interface module 4. Joystick 1 provides speed input information to controller 2. Wheel drive motor 3 is driven by controller 2 in response to the input from joystick 1 so as to attain the speed requested by a user.

User interface module 4 includes up/down buttons 8, 9. In response to actuation of buttons 8 and 9 controller 2 applies drive signals to motor 6 to raise and lower the seat of the vehicle.

Data may be communicated to controller 2 via interface port 7. This enables user profile information and the like to be communicated to controller 2 so that it operates within parameters appropriate to the user profile.

Display device 5 indicates the current speed and/or maximum allowable speed in a manner that is more fully illustrated in the following drawings.

The electric vehicle is capable of operating in a number of modes. The mode may be determined by user profile information supplied to the controller. Alternatively, the mode may be determined based upon the configuration of the electric vehicle, such as seat height. If the height of the seat of the vehicle is adjusted the maximum allowable speed is preferably limited accordingly.

Controller 2 determines the appropriate output to wheel drive motor 6 based on user input via joystick 1. According to one embodiment controller 2 generates output signals to drive display device 5 based on its calculation of current vehicle speed in accordance with user input, and not based on any actual measurement of vehicle speed. The current vehicle speed may be calculated according to one or more algorithm or based on data estimating current speed utilising historical speed and user input information. According to another embodiment controller 2 monitors a parameter of drive motor 6, such as terminal voltage, and determines vehicle speed based on this.

Although FIG. 1 shows a joystick 1 as the user input device to control vehicle speed a user input device such as user input device 4 could be used to control vehicle speed utilising up down buttons 8 and 9. Likewise, a potentiometer could be utilised to control vehicle speed.

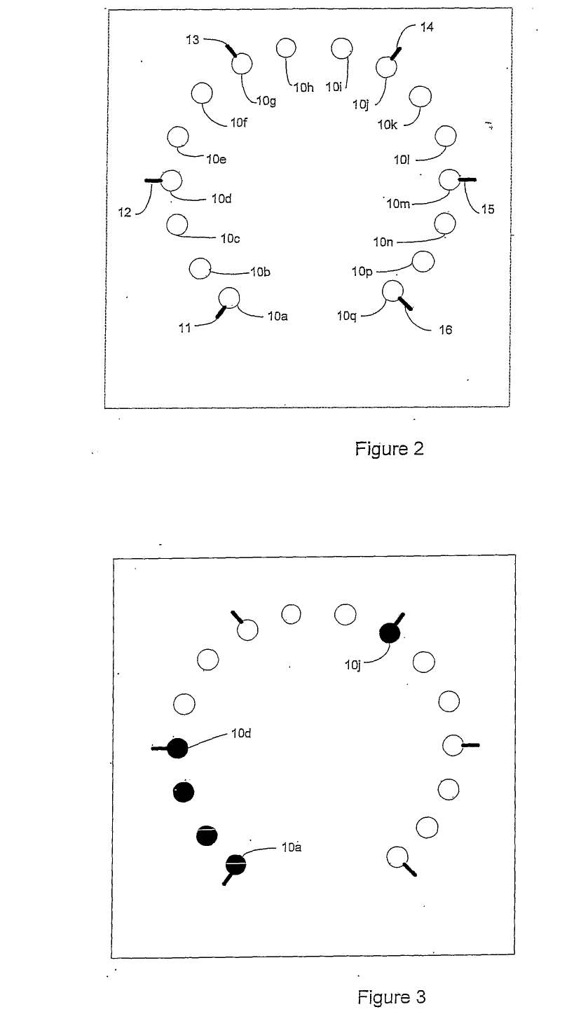

Referring now to FIG. 2 a display according to preferred embodiment is shown. This display includes 15 display elements 10a to 10q in a semicircular arrangement. The display elements may be LEDs, lamps etc. Interval markings 11 to 16 are provided at proportions of full speed: 0% (11); 20% (12); 40% (13); 60% (14); 80% (15); and 100% (16).

Referring now to FIG. 3, a first display method is shown. According to this method current vehicle speed is indicated by actuating all display elements 10a to 10d in a clockwise manner up to and including the display element indicating current vehicle speed (10d). Display element 10j is illuminated to indicate the maximum allowable speed in the current mode of operation.

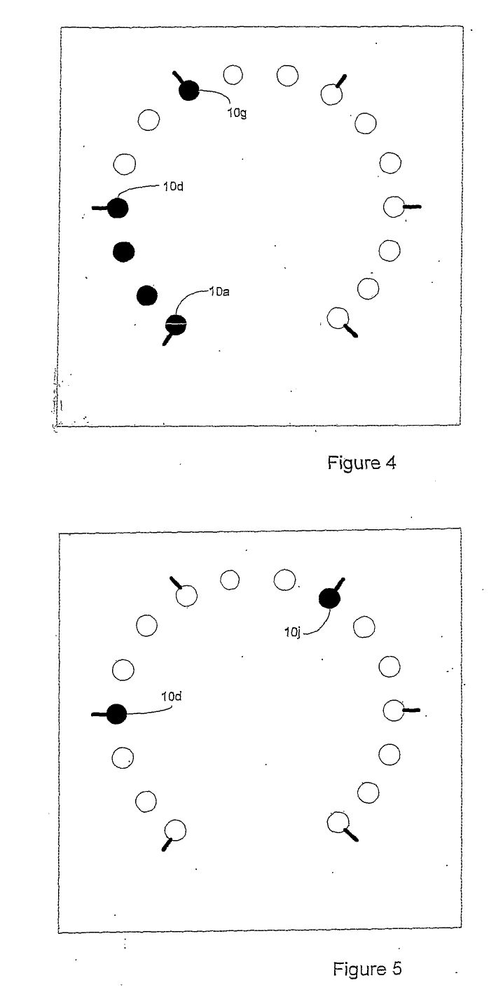

FIG. 4 shows how the display changes when the mode of operation is changed. For example, if the seat of the vehicle is raised by actuating button 9, the mode of operation may change so that the maximum allowable speed is adjusted to be 40% of the maximum possible speed. To indicate the change in maximum allowable speed display element 10g is illuminated instead of display element 10j. During a change in mode of operation the user may be notified of the change by one or more display elements flashing during the change. In this way a user is notified that the maximum allowable speed has been reduced from 60% to 40% of the maximum allowable speed.

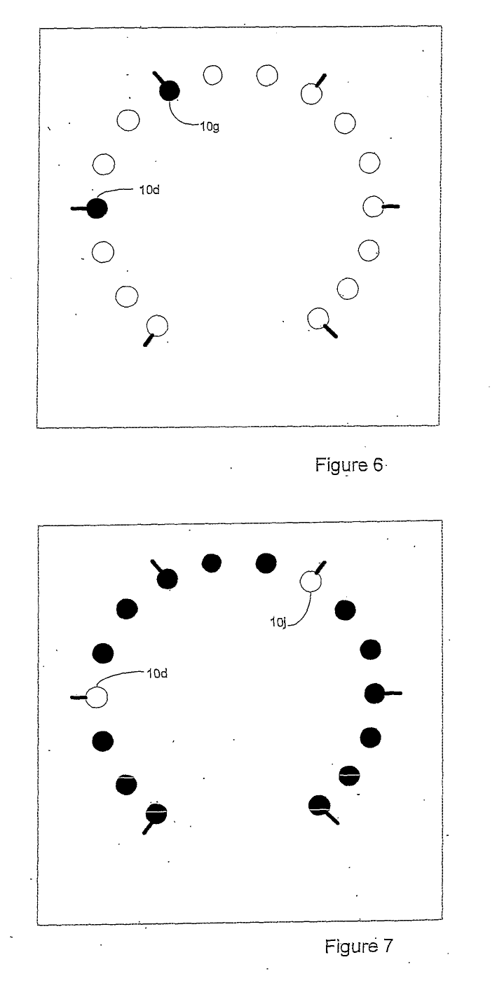

Referring now to FIG. 5 an alternative display method is shown. This method is similar to that of FIGS. 3 and 4 except that only a single display element 10d is illuminated to display current speed. FIG. 6 is analogous to FIG. 4 where the maximum allowable speed has been reduced from 60% to 40%.

FIG. 7 shows a display method in which the display elements are driven in an inverse manner to that of FIGS. 5 and 6. Instead of illuminating a display element corresponding to the current speed and the maximum allowable speed, all display elements are illuminated except for the display elements indicating current speed 10d and maximum allowable speed 10j.

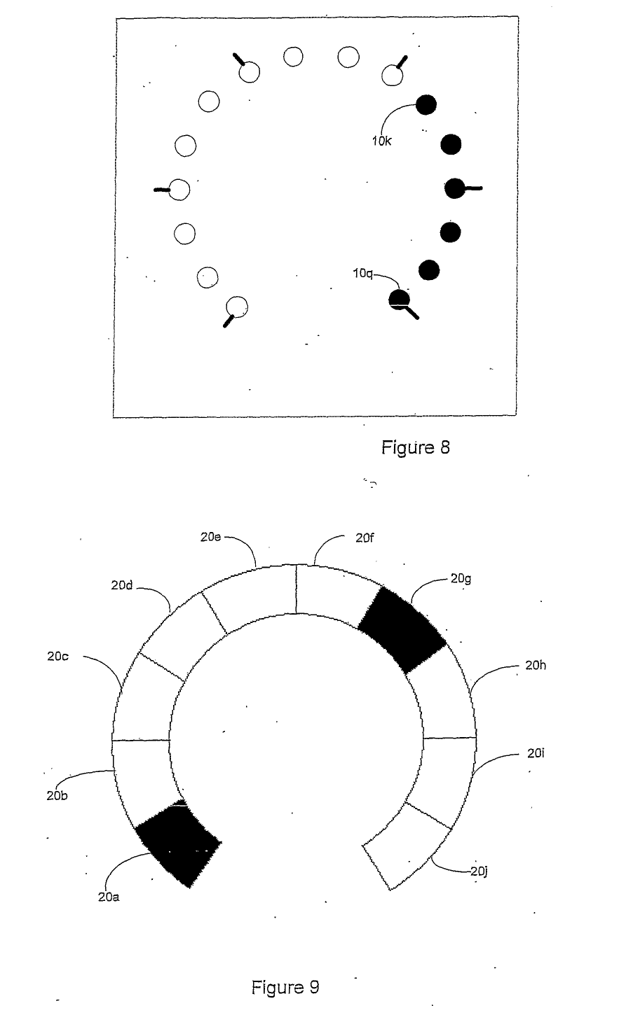

Referring now to FIG. 8 a further alternative display method is shown. According to this method all display elements between and including the display elements indicating the current speed 10k and the maximum allowable speed 10q are illuminated.

FIG. 9 shows an LCD display consisting of 10 display segments 20a to 20j implementing a display method analogous to that shown in FIG. 5. It will be appreciated that any of the display methods described above may be implemented using such an LCD display.

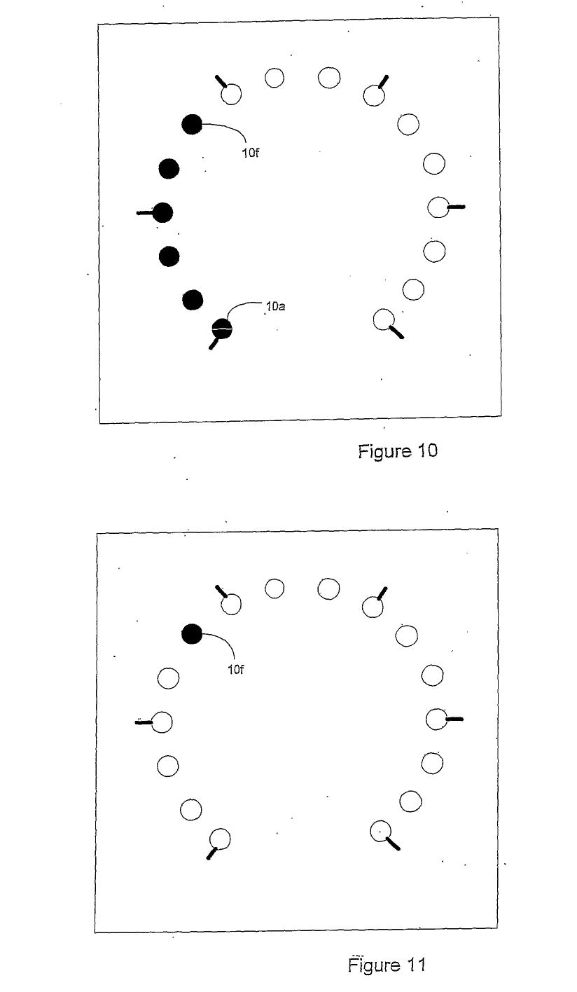

A further method for displaying current vehicle speed in relation to the maximum allowable vehicle speed is to effectively rescale the display when the mode of operation changes. Thus, with reference to FIG. 2, display element 10q would always display the maximum speed allowable for any given mode of operation. Thus, for any given mode of operation, the display elements will be actuated to represent vehicle speed as a proportion of the maximum allowable speed for the current mode of operation. Thus, for the example shown in FIG. 3, the speed would be indicated as a third of the maximum allowable speed as shown in FIG. 10, or the alternative embodiment shown in FIG. 11 where a single element is actuated.

One or more display element may flash during a change in mode to indicate to a user that a change in mode has occurred. Sometimes vehicles are deliberately programmed so that the maximum allowable vehicle speed is less than the maximum possible vehicle speed. Accordingly, in another method the display may be rescaled to represent the maximum allowable vehicle speed as a proportion of the maximum possible vehicle speed.

There is thus provided a simple display which clearly communicates to a user the maximum allowable speed for any given mode of operation. The user also knows their current speed in relation to the maximum allowable speed. Further, the calculation of current speed based on user input information greatly simplifies the provision of useful speed information to a user and reduces cost.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An electric vehicle capable of operating in a number of modes having different maximum allowable speeds including:
a user input device;
one or more drive motors for driving one or more wheels of the vehicle;
a controller for providing drive signals to the one or more drive motors in response to user input via the user input device, wherein the controller is operable in a plurality of modes allowing different maximum operating speeds; and
a display device including a number of display elements which display the speed of the vehicle by activating a proportion of display elements corresponding to the ratio of the speed of the vehicle to a maximum allowable speed for the mode of operation.

2.-14. (canceled)

15. An electric vehicle capable of operating in a number of modes having different maximum allowable speeds including:
a user input device;
one or more drive motors for driving one or more wheels of the vehicle;
a controller for providing drive signals to the one or more drive motors in response to user input via the user input device, wherein the controller is operable in a plurality of modes allowing different maximum operating speeds; and
a display including one or more display elements which display the maximum allowable speed of the vehicle for the selected mode of operation.

16.-37. (canceled)

38. A display device for an electric vehicle capable of operating in a number of modes having different maximum allowable speeds wherein the display device includes a number of display elements which display the speed of the vehicle by actuating a proportion of the display elements corresponding to the ratio of the speed of the vehicle to a maximum allowable speed for the mode of operation.

39. A display device for an electric vehicle as claimed in claim 38 wherein the display elements are configured in a progressive arrangement.

40. A display device for an electric vehicle as claimed in claim 39 wherein display elements are cumulatively actuated in sequence to indicate vehicle speed.

41. A display device for an electric vehicle as claimed in claim 39 wherein display elements are cumulatively deactuated in sequence to indicate vehicle speed.

42. A display device for an electric vehicle as claimed in claim 39 wherein a single display element is actuated indicative of current vehicle speed.

43. A display device for an electric vehicle as claimed in claim 39 wherein all display elements are actuated apart from a single display element which is deactuated to indicate current vehicle speed.

44. A display device for an electric vehicle as claimed in claim 38 wherein all display elements are actuated when the actual speed of the vehicle is equal to the maximum allowable speed for the mode of operation.

45.-47. (canceled)

48. A display device for an electric vehicle as claimed in claim 38 wherein the maximum speed value is dependent upon the height of a seat of the vehicle.

49. A display device for an electric vehicle as claimed in claim 38 wherein the maximum speed value is dependent upon user profile information.

50. A display device for an electric vehicle as claimed in claim 38 wherein the maximum speed value is dependent upon the conditions in which the vehicle is being used.

51. A display device for an electric vehicle as claimed in claim 38 wherein one or more of the display elements flash during a change in operating mode.

52. A display device for an electric vehicle capable of operating in a number of modes having different maximum allowable speeds wherein the display device includes one or more display element which displays the maximum allowable speed of the vehicle for the selected mode of operation.

53. A display device for an electric vehicle as claimed in claim 52 wherein the display elements are configured in a progressive arrangement.

54. (canceled)

55. A display device for an electric vehicle as claimed in claim 53 wherein a single display element is actuated to indicate the maximum allowable speed for the selected mode of operation.

56. A display device for an electric vehicle as claimed in claim 53 wherein a single display element is actuated to indicate current vehicle speed.

57. A display device for an electric vehicle as claimed in claim 53 wherein display elements are actuated cumulatively in sequence up to and including the display element indicative of current vehicle speed.

58. (canceled)

59. A display device for an electric vehicle as claimed in claim 53 wherein a display element is deactuated to indicate the maximum allowable speed for the selected mode of operation whilst the surrounding display elements are actuated.

60. A display device for an electric vehicle as claimed in claim 59 wherein a display element is deactuated to indicate current vehicle speed.

61. A display device for an electric vehicle as claimed in claim 52 wherein the maximum allowable speed value is dependent upon the height of a seat of the vehicle.

62. A display device for an electric vehicle as claimed in claim 52 wherein the maximum allowable speed value is dependent upon user profile information.

63. A display device for an electric vehicle as claimed in claim 52 wherein the maximum allowable speed value is dependent upon the conditions in which the vehicle is being used.

64.-76. (canceled)
